(19) United States
(12) Patent Application Publication
(10) Pub. No.: US 2025/0292684 A1
(43) Pub. Date: Sep. 18, 2025

(54) SENSOR FUSION-BASED EARLY WARNING SYSTEM

(71) Applicant: J Humble & A Muthiah, Sydney (AU)

(72) Inventor: Annamalai Muthiah, Ngunnawal (AU)

(21) Appl. No.: 19/225,100

(22) Filed: Jun. 2, 2025

Related U.S. Application Data
(63) Continuation-in-part of application No. PCT/AU2023/051241, filed on Dec. 1, 2023.

(30) Foreign Application Priority Data
Dec. 1, 2022 (AU) 2022903663

(51) Int. Cl. G08G 1/16; G01S 13/86; G01S 13/88; G01S 13/931; G08G 1/052

(52) U.S. Cl. CPC G08G 1/164; G01S 13/867; G01S 13/886; G01S 13/931; G08G 1/052; G08G 1/166

(57) ABSTRACT

The present invention relates to a warning system and in particular to a warning system that is movable to a monitoring zone. The invention has been developed primarily for use for early notification of danger by approaching vehicles to a monitored zone such as an emergency in an emergency lane of a roadway. The warning system of the invention comprises at least two forms of detectors for detecting and tracking vehicles and obtaining characteristics of the tracked vehicle relative to the monitored zone a determinator for receiving the characteristics of the tracked vehicle relative to the monitored zone and assessing the expected relative impact of the vehicle on the monitored zone and an alarm system for providing an alarm action according to a predetermined danger of the assessed expected relative impact of the vehicle to the monitored zone.

### CROSS-REFERENCE TO RELATED APPLICATIONS

This application is a continuation-in-part of International Patent Application No. PCT/AU2023/051241 filed on Dec. 1, 2023, which claims the benefit of Australian Provisional Patent Application No. 2022903663 filed on Dec. 1, 2022, the contents of which are incorporated herein by reference in their entirety.

### FIELD OF THE INVENTION

The present invention relates to a warning system and in particular to a warning system that is movable relatively to a monitoring zone.

The invention has been developed primarily for use for early notification of danger of objects such as falling objects at building sites or moving objects at bulk cargo or warehousing sites or by approaching vehicles to a monitored zone.

This can include an emergency in an emergency lane of a roadway and will be described hereinafter with reference to this application. However, it will be appreciated that the invention is not limited to this particular field of use.

### BACKGROUND OF THE INVENTION

Detection of vehicles is needed in a range of systems. However the concept of merely having a sensor and determining what is being sensed is not able to simply be used in practice. Instead there are always a multitude a limitations of the sensors, a multitude of environmental conditions that change the operation of the systems and a multitude of different instances of situations being sensed that are not the same. Further if a wrong assessment occurs this can result in a devastating effect.

Detection of vehicles in prior art systems have the problems of a lot of false alarms. In one form there is not angular resolution and hence a lot of false alarms from vehicles being identified in the wrong lane of a roadway and not in the emergency lane. This false alarm means that the people in the emergency lane scatter when they do not need to. If false alarms continue at a high rate then the detections are ignored as not likely to be of concern. The outcome of ignoring a detection can be a fatality.

Another major problem of known warning systems is that they are not effective. Merely advising of detection is not sufficient and does not fulfil a safe environment at the monitoring zone.

The present invention seeks to provide a warning system, which will overcome or substantially ameliorate at least one or more of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to a first aspect of the present invention, there is provided a warning system for early notification of danger by approaching vehicles to a monitored zone comprising at least two forms of detectors for detecting and tracking vehicles and obtaining characteristics of the tracked vehicle relative to the monitored zone a determinator for receiving the characteristics of the tracked vehicle relative to the monitored zone and assessing the expected relative impact of the vehicle on the monitored zone and an alarm system for providing an alarm action according to a predetermined danger of the assessed expected relative impact of the vehicle to the monitored zone.

It can be seen that the invention of a warning system providing the benefit of the camera radar fusion allowing for less false alarms because the computer vision based object detection is able to confirm the radar detection.

Signals transmitted and received at microwave wavelengths are resistant to impairment from poor weather (such as rain, snow, and fog), and active ranging sensors do not suffer reduced performance during night time operation. Therefore, radars do not have the same modes of failure as other sensing modalities, and compliment other perception inputs to autonomous driving such as camera and LiDAR.

In one form the invention provides a method of early notification of danger by approaching vehicles to a monitored zone including the steps of: (a) providing at least two forms of detectors for detecting and tracking vehicles and obtaining characteristics of each tracked vehicle; (b) predefining a monitored zone which requires early notification of danger by approaching vehicles; (c) focusing the at least two forms of detectors on a watch area which includes at least one area that is predetermined to cover a substantial portion of the expected detected and tracked vehicles that could have a danger at the monitored zone; (d) monitoring the characteristics of each tracked vehicle relative to the monitored zone; (e) comparing the monitored characteristics with predetermined characteristics that are considered dangers with regard the monitored zone; and (f) providing a warning based on the comparing of the monitored characteristics with predetermined characteristics that are considered dangers with regard the monitored zone.

This method and system provides improvements over the prior art including any one or more of the following:
the ability to allow use in transport businesses over a wide variety of activities on complex sites;
improving transport safety so as to aid being leaders in safety technology for competitive advantage in road services and transport control contracts;
early warning as a valuable safety concept across a range of uses; and overcoming previous technology trials that were unsuccessful due to a number of reasons including robustness and configuration.

The early warning solution of the invention can assist in providing one or more of: (a) providing a broad coverage across a site to capture a wide variety of risks in complex situations; (b) robustness to limit false alarms (the main cause of previous technology trial failure); (c) immediate automated response to workers and public via multiple means (VMS, radio, buzzer, etc.); (d) bolt-on for both static and mobile platforms; (e) easy setup and configuration.

The invention also provides a warning system wherein the alarm action includes one or more of an audible warning, a visual warning, an instructional sign warning and/or a haptic sensory warning.

Preferably the warning system is removably locatable at the monitoring zone by being set up on static platforms and/or mobile platforms.

The alarm system can include one or more of: (a) relaying to a first alarm approaching the monitoring zone; (b) relaying to a second alarm to alert the people at the monitoring zone; and (c) relaying to a third alarm to alert the people at or near the monitoring zone.

In this way there is a full warning to the person approaching the monitoring zone, to the person at the monitoring zone trying to ensure safety and to the person at or near the monitoring zone trying to provide service such as the first responders.

The invention can provide a warning system for early notification of danger posed by approaching objects to a monitored zone, the system comprising at least two distinct types of detectors configured to detect and track objects and obtain characteristics of a tracked object relative to the monitored zone. The system includes a processor communicatively coupled to the at least two distinct types of detectors, and an alarm system communicatively coupled to the processor. The alarm system is configured to provide an alarm action based on a predetermined danger level associated with the assessed expected relative impact of the tracked object on the monitored zone.

The processor can be configured to receive the characteristics of the tracked object relative to the monitored zone and assess an expected relative impact of the tracked object on the monitored zone based on said characteristics.

The monitored zone is predefined, and a watch area is defined relative to the monitored zone, the watch area including an area predetermined to cover trajectories of expected detected and tracked objects that pose a potential threat to the monitored zone, or falling objects at a building site or movable objects at a cargo site or warehouse or other monitored moving objects.

The at least two distinct types of detectors are configured to monitor at least one of the first distant area or the second distant area, said detectors being selected based on possessing complementary operational characteristics across a plurality of distinct performance parameters, wherein the complementary nature of said characteristics enables the system to:
(i) leverage a strength of a first of said detector types to compensate for a corresponding weakness or limitation of a second of said detector types with respect to at least one of said performance parameters; and
(ii) perform crosschecking of detections derived from said detector types, thereby enhancing overall detection reliability and limiting false alarms.

The at least two distinct types of detectors can comprise a combination of at least one visual camera and at least one sensor selected from the group consisting of radar and LiDAR, said combination inherently exhibiting said complementary operational characteristics across performance parameters including at least illumination dependency, weather robustness, angular resolution, and target classification capability.

In one form, the plurality of distinct performance parameters, which contribute to the complementary operational characteristics, further includes parameters related to sensor configuration or intrinsic capabilities, selected from the group consisting of: detection range, noise immunity, velocity tracking accuracy, height tracking capability, distance tracking accuracy, different focal lengths, different depths of field, and different sensor data processing times, to ensure robust assessment of tracked objects.

The plurality of distinct performance parameters comprises at least three parameters selected from the group consisting of:
(a) performance under varying illumination conditions;
(b) performance in adverse weather conditions;
(c) susceptibility to signal noise;
(d) maximum and minimum detection range;
(e) angular resolution;
(f) accuracy of velocity tracking;
(g) accuracy of height tracking;
(h) accuracy of distance tracking; and
(i) capability for target classification.

The visual camera and the at least one sensor selected from the group consisting of radar and LiDAR are configured to cooperatively detect and track vehicles within the watch area and obtain said characteristics of the tracked vehicle at each watch area relative to the monitored zone.

The at least two distinct types of detectors can be configured to detect and track objects approaching the monitored zone from a plurality of different angles of incidence and over a range of relative velocities.

The detectors can be configured to detect and track vehicles at a first distance of at least 180 meters from the monitored zone for horizontal traffic use or for vertical risk detection.

The processor is further configured to determine a distance of the tracked vehicle to the monitored zone and an apparent speed of the tracked vehicle; and calculate a predictive alarm timing for latency compensation, wherein the predictive alarm timing is based on an assessed risk and trajectory of the approaching tracked vehicle, a configurable or learned latency value associated with the alarm system; and a required time for the alarm action to be effective at a target location within or near the monitored zone.

The alarm system can be configured to perform one or more of transmitting a first alert signal to an approaching vehicle to warn of danger at the monitored zone, activating a second alert signal, such as an air horn or beeping sound, to alert personnel at the monitored zone, or activating a third alert signal, such as a pager notification, to alert personnel undertaking actions at or near the monitored zone, including vehicle service personnel or first responders.

The alarm system is configured to provide a graded warning based on a severity level of a predetermined danger, and wherein the alarm system is further configured to initiate an emergency activation for highest severity dangers.

The at least two distinct types of detectors are selected from modalities including:
(a) a radar detector, optionally a short-range Doppler radar detector;
(b) a vision-based detector (camera);
(c) a thermal-based detector (camera);
(d) a sonar detector; and
(e) a LiDAR detector.

The invention can also provide a method of providing early notification of danger posed by approaching vehicles to a monitored zone, the method comprising the steps of utilizing at least two distinct types of detectors to detect and track vehicles and obtain characteristics of each tracked vehicle relative to the monitored zone, predefining the monitored zone for which early notification of danger is required configuring the at least two distinct types of detectors to monitor a watch area, the watch area including at least one area predetermined to cover trajectories of expected detected and tracked vehicles that pose a potential threat to the monitored zone, monitoring, via the detectors, the characteristics of each tracked vehicle relative to the monitored zone, comparing, using a processor, the monitored characteristics with predetermined characteristics that are considered dangers with regard to the monitored zone, wherein said predetermined characteristics relate to people and assets at the monitored zone; and providing, via an alarm system, a warning based on said comparison.

The step of utilizing at least two distinct types of detectors comprises selecting or configuring said detector types to possess complementary operational characteristics across a plurality of distinct performance parameters, such that data fusion leverages a strength of a first of said detector types to compensate for a corresponding weakness or limitation of a second of said detector types with respect to at least one of said performance parameters, thereby enhancing overall detection reliability and limiting false alarms when providing the warning.

The system can further comprise classifying an object at long distances using sensor fusion of data from a camera and a radar detector, including the steps of processing radar data from the radar detector to detect potential targets at long range and applying a clustering algorithm to identify 3D radar clusters, projecting one or more centroids or bounding boxes of the 3D radar clusters onto a 2D image plane of the camera, using the projected 2D locations as regions of interest or anchors for a computer vision (CV) algorithm operating on image data from the camera; and refining detection by applying the CV algorithm to focus detection efforts within or around the radar-suggested 2D locations, thereby guiding CV detection for small, low-pixel, long-range targets.

Other aspects of the invention are also disclosed.

### BRIEF DESCRIPTION OF THE FIGURES

Notwithstanding any other forms which may fall within the scope of the present invention, preferred embodiments of the invention will now be described, by way of example only, with reference to the accompanying drawings in which:

FIG. 1 is a diagrammatic view of components of a warning system for early notification of danger by approaching vehicles to a monitored zone in accordance with a preferred embodiment of the present invention;

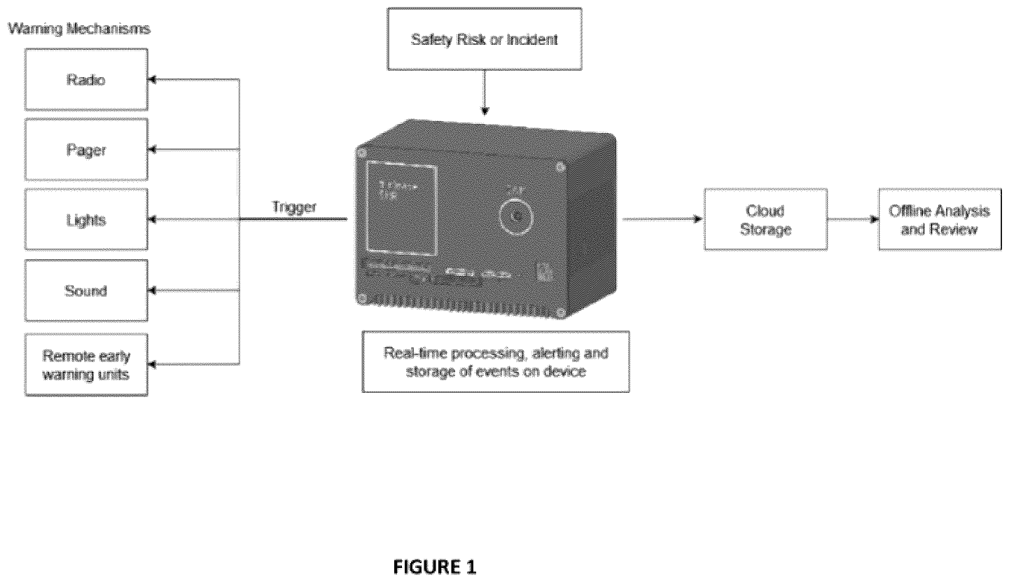

FIG. 2 is for a diagrammatic view of the circuitry of control for the warning system of FIG. 1;

FIG. 3 is a diagrammatic view of the use of the warning system when mounted at the rear of a monitoring vehicle to protect the monitoring zone of the work zone with diagrammatic view of the effect of multiple detectors to avoid false readings;

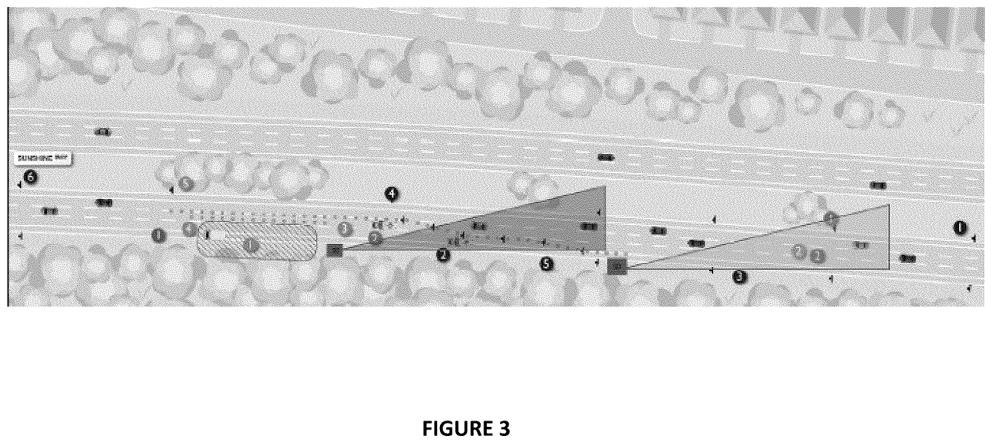

FIG. 4 is a diagrammatic view of examples of the components of the warning system of FIG. 1 including pagers, buzzers, visual warnings, etc.;

FIG. 5 is a diagrammatic view of early notification of danger by approaching vehicles to a monitored zone in accordance with another preferred embodiment of the present invention in which there are multiple detectors including auxiliary detector further down the riad from the monitoring zone of a multi lane closure of a divided carriageway so as to interact with closer detectors to enhance and improve effectiveness of warnings;

FIG. 6 is a diagrammatic box view of the method of early notification of danger by approaching vehicles to a monitored zone;

FIG. 7 is a schematic block diagram illustrating the overall architecture of an exemplary sensor fusion-based early warning system in accordance with an embodiment of the present invention;

FIG. 8 is a conceptual diagram illustrating an exemplary marker-based sensor calibration setup in accordance with an embodiment of the present invention;

FIG. 9 is a conceptual diagram illustrating an exemplary markerless sensor calibration process in accordance with an embodiment of the present invention;

FIG. 10 is a schematic diagram illustrating different levels of sensor fusion by data abstraction that can be employed by the system in accordance with an embodiment of the present invention;

FIG. 11 is a process flow diagram illustrating an exemplary radar-anchored computer vision process for enhanced long distance object detection in accordance with an embodiment of the present invention;

FIG. 12 is a conceptual diagram illustrating various methods for dynamic zone definition supported by the system in accordance with an embodiment of the present invention;

FIG. 13 is a process flow diagram illustrating an exemplary logic for assessing risk based on vehicle deceleration characteristics relative to a critical distance from a monitored zone, in accordance with an embodiment of the present invention;

FIG. 14 is a process flow diagram illustrating an exemplary intelligent alert timing module incorporating predictive latency compensation, in accordance with an embodiment of the present invention; and

FIG. 15 is a schematic block diagram illustrating an exemplary hybrid edge-cloud processing architecture with intelligent data streaming, in accordance with an embodiment of the present invention.

### DETAILED DESCRIPTION OF SPECIFIC EMBODIMENTS

It should be noted in the following description that like or the same reference numerals in different embodiments denote the same or similar features.

Referring to the drawings there is shown for early notification of danger by approaching vehicles to a monitored zone.

The warning system for early notification of danger by approaching vehicles to a monitored zone comprises at least two forms of detectors for detecting and tracking vehicles and obtaining characteristics of the tracked vehicle relative to the monitored zone. A determinator for receiving the characteristics of the tracked vehicle relative to the monitored zone and assessing the expected relative impact of the vehicle on the monitored zone. An alarm system for providing an alarm action according to a predetermined danger of the assessed expected relative impact of the vehicle to the monitored zone.

In one form this can be achieved in which there are two hardware units consisting of cameras, radar and an edge computer and deploy them onto two TMAs. Software is capable of fusing camera and radar sensor inputs to detect the speed, distance, direction, height and type of vehicles in unique lanes. The system will trigger an early warning response based on vehicle braking distance (notionally 250 m). The early warning response will alert the public vehicle through a specific message via VMS and strobing beacons as well as workers in front of the TMA will be alerted via a wearable buzzer.

The device can be mounted to stationary or mobile structure such as: (i) tripod; (ii) pole with solar power; (iii) VMS display board (trailer mounted or otherwise); (iv) traffic management attenuator (TMA) (which are trucks with crash barriers); and (v) incident response vehicle (van).

### I. System Architecture and Core Components

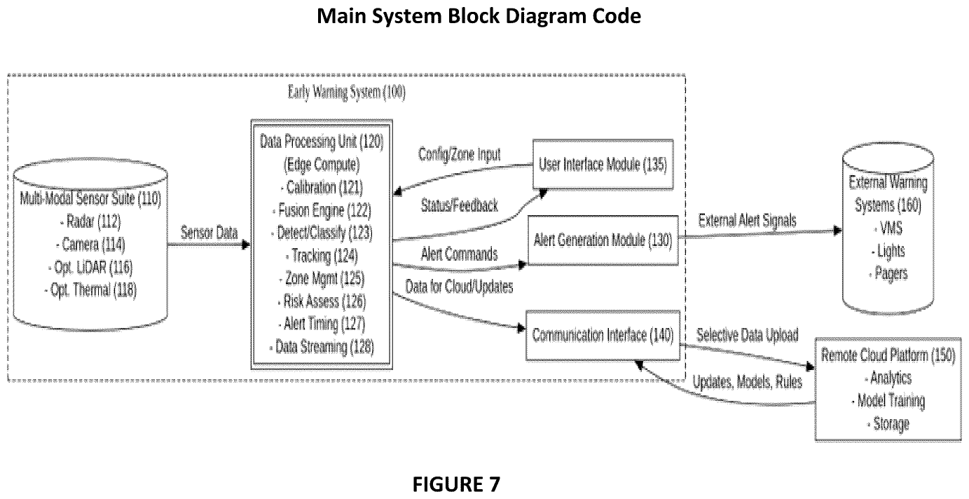

Referring to FIG. 7, the early warning system (100) of the present invention generally comprises a multimodal sensor suite (110), a central data processing unit (120), an alert generation module (130), a user interface module (135), and, in certain embodiments, a communication interface (140) for connectivity with a remote cloud platform (150) and/or external distributed warning systems (160).

The sensor suite (110) is responsible for acquiring comprehensive data pertaining to the monitored environment, including the detection and characterization of objects (which may include vehicles, machinery, personnel, or other relevant entities) within a predefined watch area. In a preferred embodiment, the sensor suite (110) includes at least one radar sensor (112) and at least one vision-based sensor (camera) (114). The radar sensor (112), which may be a FMCW (frequency modulated continuous wave) radar or a pulse-Doppler radar, is selected for its proficiency in long-range detection, accurate velocity measurement, and robust performance across varying weather conditions (e.g., rain, fog, snow) and illumination levels (e.g., day, night). The vision-based sensor (114), typically a high-resolution CCD or CMOS digital camera, is selected for its superior angular resolution, ability to capture rich textural and color information essential for object classification, and its utility in visual-based zone definition. It is expressly contemplated that the sensor suite (110) can be augmented or modified with other sensor modalities, including but not limited to LiDAR (light detection and ranging) sensors (116) for precise 3D point cloud generation, thermal imaging cameras (118) for detection based on heat signatures, and/or acoustic sensors (not shown). The selection and combination of these sensors are deliberately chosen to exploit their complementary operational characteristics, wherein the strengths of one sensor type compensate for the limitations of another, leading to a synergistic improvement in overall system perception and reliability.

The data processing unit (120), often implemented as an embedded system with one or more processors (e.g., CPUs, GPUs, FPGAs, or specialized AI accelerators) and associated memory, serves as the central intelligence of the system. It is communicatively coupled to each sensor in the suite (110) and is configured by software/firmware to execute a plurality of advanced processing modules. These modules include, but are not limited to: a sensor calibration module (121), a multistrategy sensor fusion engine (122), an object detection and classification module (123), an object tracking module (124), a dynamic zone management module (125), a predictive risk assessment module (126), and an intelligent alert timing module (127). In embodiments featuring cloud connectivity, the processing unit (120) also manages intelligent data streaming (128) to the cloud platform (150).

The alert generation module (130) is communicatively coupled to the data processing unit (120) and is responsible for activating one or more warning mechanisms in response to a determined risk or hazard. These mechanisms can include integrated alerts (e.g., on-board visual displays, audible alarms, haptic feedback devices) or commands to external systems (160) such as variable message signs (VMS), strobe lights, remote pagers for personnel, or even direct control signals to worksite machinery in advanced implementations.

The user interface module (135) provides means for system configuration, status monitoring, and, crucially, for the definition and adjustment of monitored zones, as will be detailed further. This interface may include a touchscreen display, physical buttons, and/or a software application accessible via a connected computing device.

The communication interface (140) may include wired (e.g., Ethernet) or wireless (e.g., WiFi, cellular [4G/5G], Bluetooth, LoRa) transceivers, enabling data exchange with the cloud platform (150) for tasks such as remote diagnostics, software updates, model retraining, and long-term data analytics, as well as for relaying alerts to distributed personnel or systems.

Ii. Sensor Calibration for Coordinated Fusion

Accurate spatial and temporal alignment of data from the heterogeneous sensors within the suite (110) is paramount for effective sensor fusion. The sensor calibration module (121) is configured to perform this critical task.

In a primary embodiment, an intrinsic and extrinsic calibration process is performed. Intrinsic calibration determines internal sensor parameters (e.g., camera focal length, principal point, lens distortion coefficients; radar antenna beam patterns or biases). Extrinsic calibration determines the precise 3D rigid body transformation (rotation and translation) between the coordinate systems of each sensor in the suite (110) and a common reference frame (often, the coordinate system of one of the primary sensors or a vehicle-fixed frame if the system is mobile).

For camera-radar calibration, the system supports multiple methodologies.

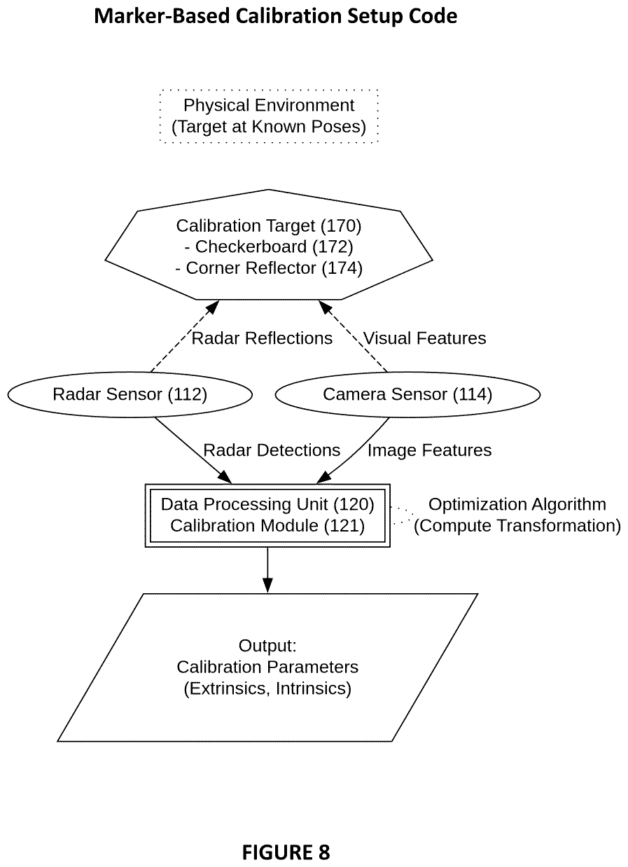

MARKER-BASED CALIBRATION: As illustrated conceptually in FIG. 8, this involves placing one or more calibration targets (170) with known geometric properties (e.g., a planar checkerboard pattern (172), a radar-reflective corner reflector (174) colocated with visual markers) at several distinct, known positions and orientations within the overlapping fields of view of the radar (112) and camera (114). The system captures corresponding sensor data (e.g., 2D image coordinates of checkerboard corners, 3D radar point detections of the reflector). An optimization algorithm, such as a least-squares solver or a more sophisticated iterative method, is then employed by the calibration module (121) to compute the transformation matrix that best aligns these corresponding detections, thereby determining the extrinsic parameters.

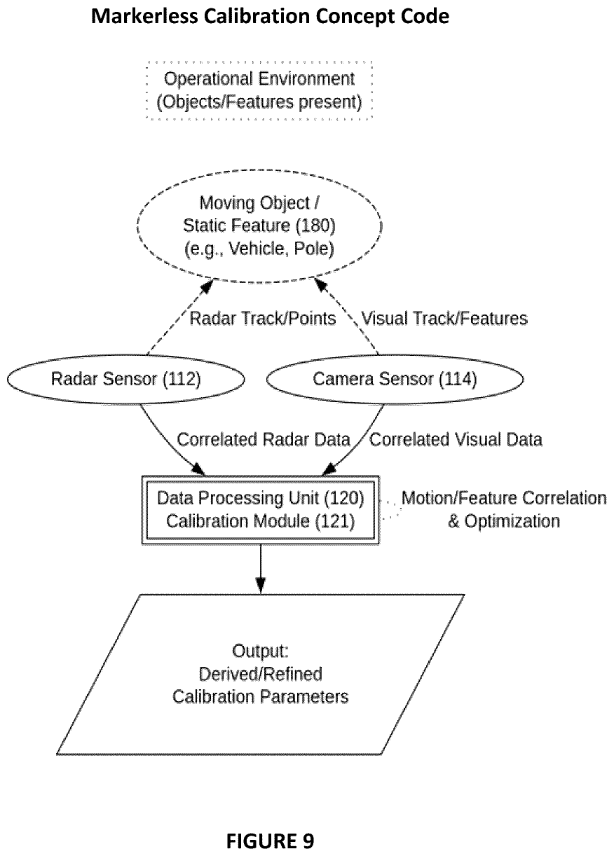

MARKERLESS (TARGETLESS) CALIBRATION: As depicted in FIG. 9, this approach obviates the need for dedicated calibration targets. Instead, the system leverages naturally occurring features or objects (180) within the operational environment that are simultaneously observable by multiple sensors. This can involve:

MOTION-BASED CALIBRATION: Observing the correlated trajectories of moving objects as independently tracked by, for example, the radar (112) and the camera (114). Algorithms such as structure-from-motion (SfM) variants or iterative closest point (ICP) applied to tracklets can be used to deduce the relative sensor poses.

APPEARANCE/FEATURE-BASED CALIBRATION: Identifying and matching salient static or dynamic features (e.g., lane markings, poles, distinct vehicle features) across sensor modalities. For instance, radar points corresponding to the edges of stationary objects can be correlated with edges detected in camera images. This markerless calibration can be performed as an initial setup step or continuously/periodically during operation to adapt to minor shifts in sensor alignment.

The output of the calibration module (121) is a set of transformation parameters that enable the data processing unit (120) to project data from one sensor's coordinate system into another's (e.g., projecting 3D radar points onto the 2D image plane of a camera, or transforming all sensor data into a common 3D world frame). This unified spatial understanding is fundamental for all subsequent sensor fusion tasks.

### III. Multistrategy Sensor Fusion Engine (Module 122)

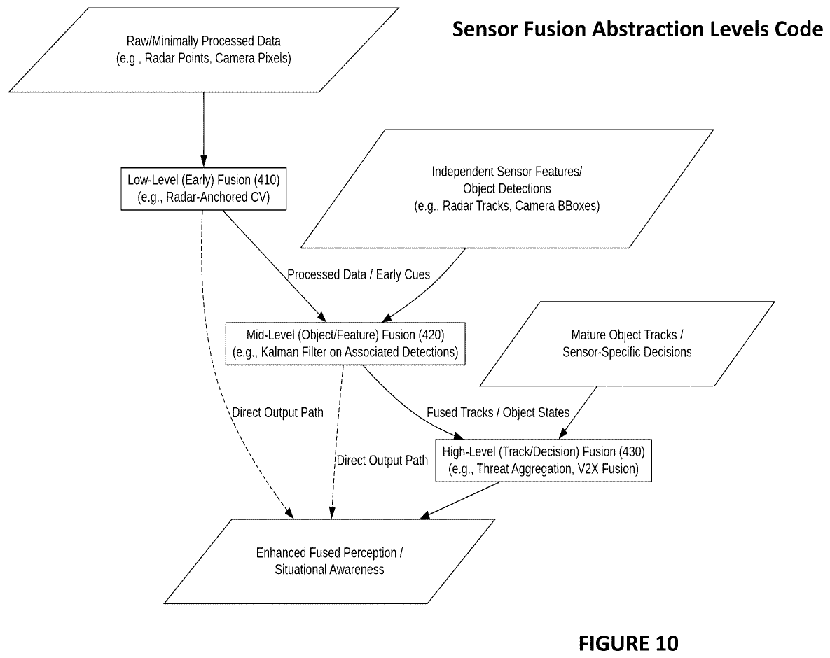

The sensor fusion engine (122) is a core innovation, designed for flexibility and optimized performance by selectively employing or combining different fusion strategies. The choice of strategy can be preconfigured, adaptively selected by the system based on real-time context (e.g., environmental conditions, object density, sensor confidence levels), or a hybrid approach combining elements of different strategies. The primary categories of fusion supported are as follows, illustrated conceptually in FIG. 10:

### A. Fusion by Abstraction Level

LOW-LEVEL (EARLY) FUSION (410): Raw or minimally processed sensor data streams are combined prior to significant feature extraction or object detection.

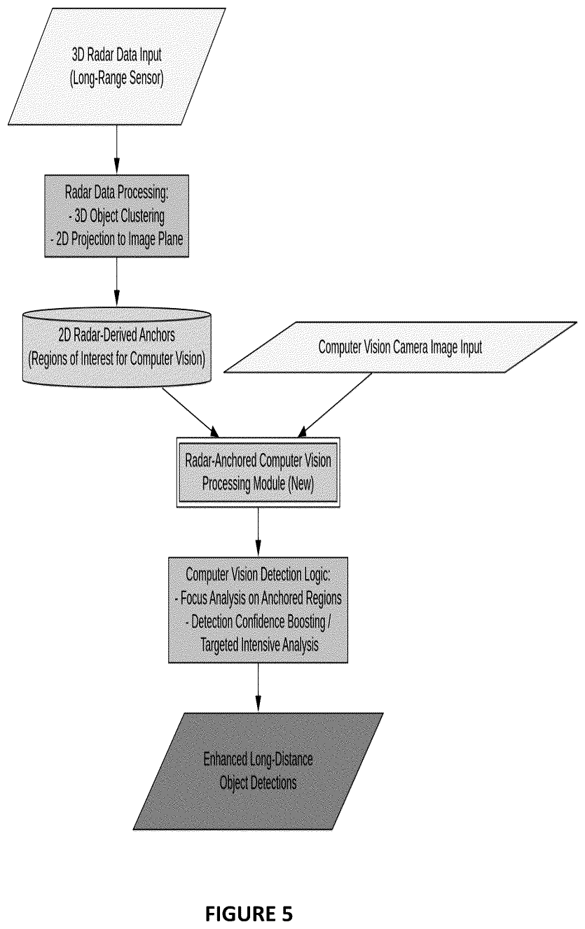

PREFERRED EMBODIMENT EXAMPLE: For enhanced long-distance object detection (further detailed in Section V and FIG. 5), raw radar point clouds from radar (112) are spatially correlated with image regions from camera (114). A radar point cluster indicative of a distant object, even if sparse, triggers a focused, higher sensitivity processing of the corresponding camera image patch. This “radar-anchoring” or “radar-cueing” of CV (114) significantly improves the probability of detecting low-pixel targets at range.

MIDLEVEL (OBJECT/FEATURE) FUSION (420): This involves fusing independently extracted features or object hypotheses from each sensor.

PREFERRED EMBODIMENT EXAMPLE: The radar (112) outputs radar tracks, and the camera (114) with its algorithms outputs 2D bounding boxes with classifications. The fusion engine (122) performs data association to match radar tracks with camera detections. Once associated, a state estimation filter (e.g., an Extended Kalman Filter) fuses the state estimates.

HIGH-LEVEL (TRACK/DECISION) FUSION (430): Mature object tracks or individual sensor-derived decisions are combined.

PREFERRED EMBODIMENT EXAMPLE: The system combines threat levels derived from different fused tracks or considers sensor-specific confidence scores. For example, a track might have high radar confidence for speed but low camera confidence for classification due to poor lighting; fusion logic then weights the radar-derived threat more heavily.

The data processing unit (120) may be configured to dynamically select or weight different fusion levels based on factors such as object range or tracking confidence.

### B. Fusion by Architectural Distribution

While the primary embodiment describes a centralized fusion engine (122) within the on-device unit (120), the architecture is extensible to distributed fusion scenarios.

### C. Leveraging Complementary Sensor Characteristics

The core design philosophy is to maximize the benefits of complementary fusion. For example, radar's (112) all-weather range detection is complemented by the camera's (114) high angular resolution and rich classification capabilities. The fusion engine (122) contains logic to appropriately weight contributions from different sensors based on their inherent strengths and real-time confidence metrics.

### IV. Dynamic Zone Definition and Management (Module 125)

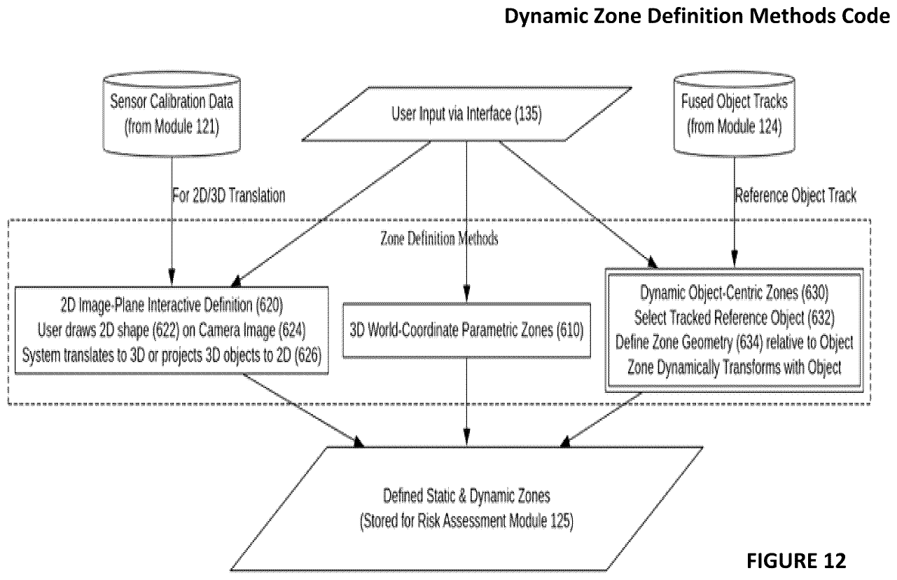

Referring to FIG. 12, the system (100) offers flexible mechanisms for defining and managing safety and operational zones via the user interface (135) and zone management module (125).

(1) 3D WORLD COORDINATE PARAMETRIC ZONES (610): Users define zones as geometric primitives (e.g., cuboids) in a 3D world coordinate system relative to a known origin or the system's location.

(2) 2D IMAGE-PLANE INTERACTIVE ZONE DEFINITION (620): Users draw a 2D region of interest (622) on a live camera image (624). The system, using sensor calibration, translates this 2D definition into a 3D monitored space or projects 3D object data onto the 2D plane (626) for intersection testing.

(3) DYNAMIC OBJECT-CENTRIC ZONES (630): A user selects a tracked reference object (632) and defines a zone geometry (634) relative to it. The module (125) continuously updates the world coordinates of this zone as the reference object moves, using its fused track data. The transformation Z_world=R_obj*Z_local
+P_obj (where P_obj, R_obj are reference object position/orientation, and
Z_local are local zone points) is applied in each cycle.

Multiple zones of different types and attributes can be active simultaneously.

### V. Advanced Object Detection, Classification, and Tracking (Modules 123, 124)

OBJECT DETECTION AND CLASSIFICATION (MODULE 123): Fused classification enhances reliability. For instance, radar (112) might detect an object's speed, while the spatially correlated camera (114) data provides visual features for a more confident classification by a fusion-aware classifier.

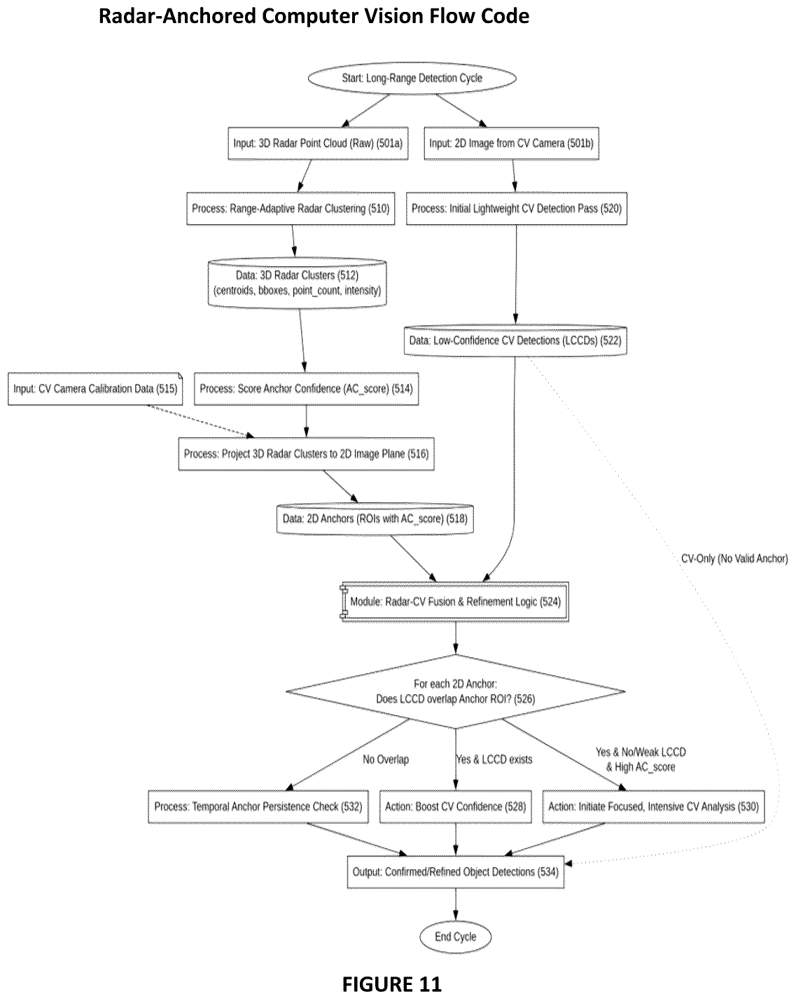

Enhanced long-distance detection (radar-anchored CV [FIG. 11]):
Radar (112) detects targets and applies range-adaptive clustering (510) to 3D point clouds (501a), yielding 3D radar clusters (512).
Clusters are scored for Anchor Confidence (AC_score) (514).
3D clusters (with AC_score) are projected (516) onto the 2D image plane of the CV camera (114) (using calibration data [515]) to form 2D anchors (ROIs) (518).
Concurrently, an initial lightweight CV detection pass (520) on the full 2D image (501b) produces low-confidence CV detections (LCCDs) (522).
The radar-CV fusion and refinement logic (524) then operates:
   (i) If an LCCD (522) overlaps a 2D anchor (518) (Decision [526]=“Yes & LCCD”), its confidence is boosted (528).
   (ii) If a high AC_score Anchor has no/weak LCCD (Decision [526]=“Yes & No/Weak LCCD & High AC”), focused CV analysis is initiated (530) within that ROI.
   (iii) If an Anchor shows no overlap and persists (Decision [526]=“No Overlap” leading to [532]), it is flagged.

This results in Confirmed/Refined Object Detections (534).

OBJECT TRACKING (MODULE 124): The system employs multiobject tracking (MOT) algorithms to maintain state vectors (3D position, velocity, acceleration, orientation, size, class, confidence) for numerous objects, using filters like EKFs or UKFs on fused data.

Vi. PREDICTIVE RISK ASSESSMENT AND INTELLIGENT ALERT TIMING (MODULES 126, 127) Predictive Risk Assessment (Module 126)

TRAJECTORY PREDICTION: The system predicts an object's future trajectory using its fused track data and appropriate motion models.

DYNAMIC ZONE INTERSECTION ANALYSIS: The predicted trajectory is compared against defined zone boundaries.

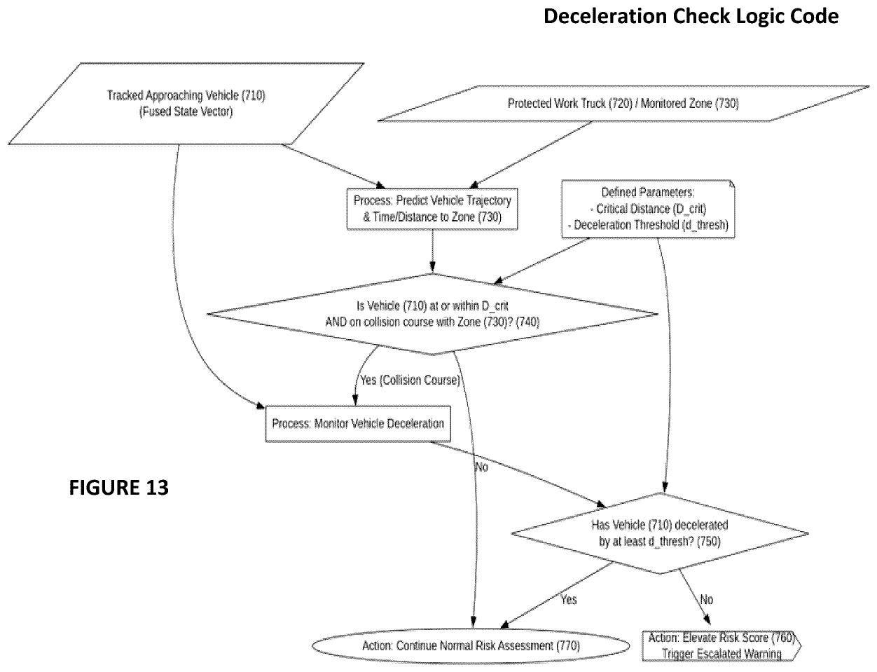

RISK PARAMETER CALCULATION: Parameters like TTI/TTC are calculated. As illustrated in FIG. 13, for an approaching vehicle (710) towards a protected zone (730) around a work truck (720), if the vehicle fails to exhibit a deceleration exceeding d_thresh by a critical distance D_crit (Decision [750]=“No”), its risk score is elevated (760).

GRADED RISK SCORE ASSIGNMENT: A dynamic, graded risk score is assigned to object-zone interactions.

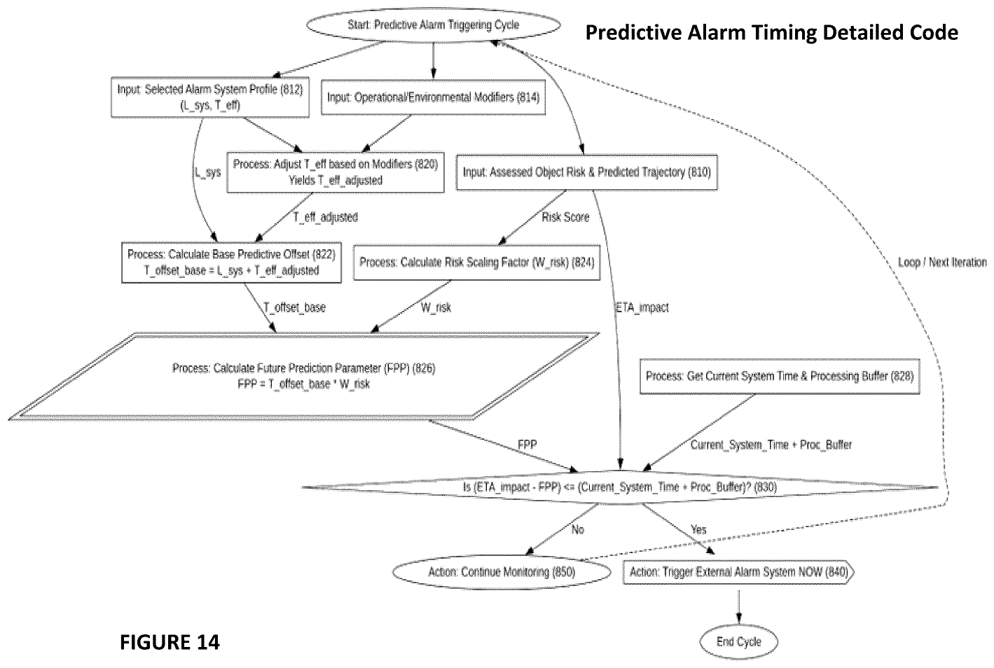

Intelligent Alert Timing Module (Module 127 [Predictive Latency Compensation] FIG. 14)

INPUT PARAMETERS: Assessed object risk and trajectory (810), alarm system profile (812) (including system latency L_sys, required effectiveness Time T_eff), and Operational/Environmental Modifiers (814).

PREDICTIVE ALARM OFFSET CALCULATION: T_eff is adjusted by modifiers (820) to T_eff_adjusted. A base offset T_offset_base=L_sys+T_eff_adjusted is calculated (822). A Risk Scaling Factor W_risk is determined (824). The Future Prediction Parameter FPP=T_offset_base*W_risk (826).

MODIFIED ALARM TRIGGER LOGIC (DECISION 830): An alarm is triggered if ETA_impact-FPP<=Current_System_Time+Processing_Buffer (using current time from [828]), leading to early trigger (840) or continued monitoring (850).

### VII. Hybrid Edge-Cloud Architecture and Intelligent Data Streaming (Modules 128, 140, 150)

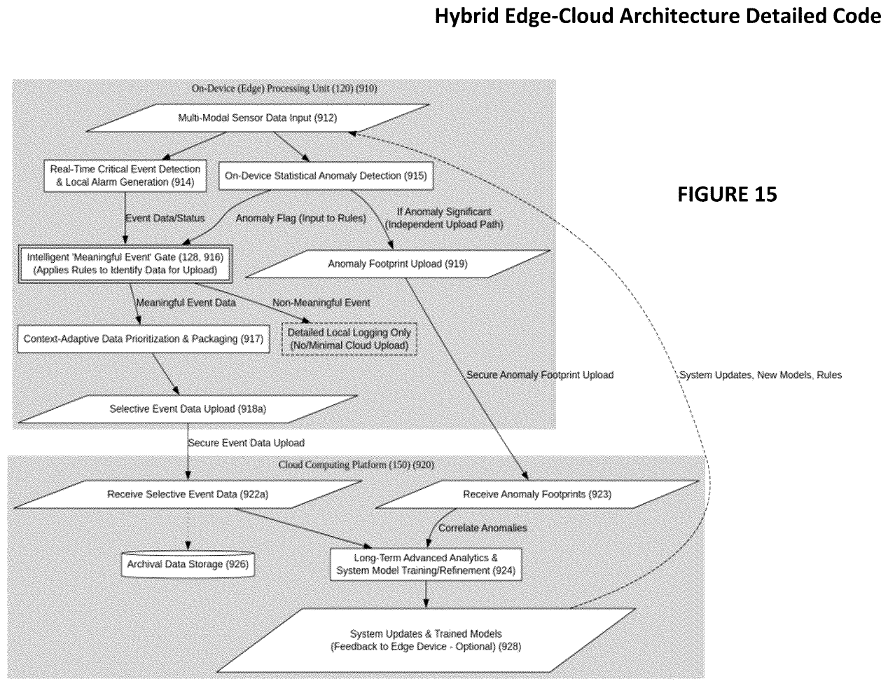

Referring to FIG. 15, the system (100) can optionally incorporate a hybrid edge-cloud architecture.

ON-DEVICE9 (EDGE) PROCESSING9 (910) BY UNIT (120): Handles sensor data acquisition (912), real-time processing, immediate alarm generation (914), and on-device anomaly detection (915). The INTELLIGENT “MEANINGFUL EVENT” DATA STREAMING LOGIC (MODULE 128, 916) decides what data is uploaded.

RULES FOR “MEANINGFULNESS”:
If RealTimeThreatAssessment. Alarm_Triggered (from [914])
If Min_TTC_NonCrit (from feature extraction)<Threshold_warn.
If Object_Behavior_Pattern==“Erratic_Swerve”
If Sensor_Health_Flags indicate anomaly
If a Cloud_Retraining_Request for a specific pattern is active and current event features match that pattern
If an On-Device_Anomaly_Detected_Flag (from [915]) is significant

DATA PACKAGING (917): Context-adaptive packaging (full buffers for critical events, keyframes/compressed tracks for others).

Data is selectively streamed (918) via interface (140). Anomaly footprints from (915) may also be streamed independently (919) if significant.

CLOUD COMPUTING PLATFORM (920) FROM UNIT (150): Receives selective event data (922) and anomaly footprints (923). It performs:
Long-term advanced analytics and system model training/refinement (924);
archival data storage (926); and
generates system updates and feedback to edge (928) (updated models, rules).

This architecture balances immediate edge response with cloud-based learning, optimized by intelligent streaming.

### VIII. Privacy-Enhanced Operational Mode

The system (100) supports a privacy-enhanced mode:
CAMERA-ASSISTED SETUP: Cameras (114) aid visual zone definition via user interface (135).
RADAR-PRIMARY OPERATIONAL MONITORING: During operation, radar(s) (112) (and/or LiDAR [116]) are primary for detection/tracking. Camera data may be used for real-time fusion, but raw video from events is not stored. Only event metadata (time, location, radar track ID, warning type) is logged. This enhances acceptance in privacy-sensitive areas while retaining camera utility for setup and fusion.

### IX. Adaptation for Vertical Risk Detection and Monitoring

The system architecture (100) is adaptable for vertical risk detection (e.g., falling materials, crane loads):
(i) SENSOR REORIENTATION: Radar(s) (112) and camera(s) (114) are aimed to monitor vertical/near-vertical zones.
(ii) ALGORITHMIC ADAPTATION (“FLIPPING TRACKING MATH”): Object tracking (module [124]) and risk assessment (module [126]) algorithms are modified:
   state vectors prioritize vertical position, velocity, acceleration;
   motion models incorporate gravity and represent falling object trajectories;
   collision prediction logic is based on vertical intersection with protected zones; and
   risk assessment considers size/mass of falling objects and profiles to distinguish controlled lifts from accidental drops. This expands utility to construction, warehousing, and manufacturing safety.

### Multiple Detectors

Detectors have their limitations. However, by synergistically combining the effects of multiple detectors.

The detectors primarily used are in one each of the categories of:
a 2D cameras which provide a 2D pixel output; and
a 3D detector that provides a 3D grid of points.

However generally the outputs cannot merely be combined. Instead, there needs to be a controlled fusion of the outputs such that a synergy of the results provides an improved result.

The electromagnetic spectrum is the range of frequencies (the spectrum) of electromagnetic radiation and their respective wavelengths and photon energies.

The electromagnetic spectrum covers electromagnetic waves with frequencies ranging from below one hertz to UV waves corresponding to wavelengths from thousands of kilometres down to a fraction of the size of an atomic nucleus. This frequency range is divided into separate bands, and the electromagnetic waves within each frequency band are called by different names; beginning at the low frequency (long wavelength) end of the spectrum these are: radio waves, microwaves, infrared, visible light, ultraviolet, X-rays, and gamma rays at the high-frequency (short wavelength) end.

TABLE 1

| | | Process | | |
|---|---|---|---|---|
| Type | Distance | Time | Problem | Preferred Usage |
| Radar or | Good for | Fast | Not effective | Tracking speed of |
| LiDAR | distance | | for detecting | distant vehicles |
| | | | angular | |
| | | | variations | |
| Visual | Average as | Fast | Cannot | To assess angular |
| detector | wavelength | | assess | variations at short |
| | of light is | | distance | and medium distances |
| | too fine | | | |

Therefore, radar is long range and can detect vehicles from 0 m to 300 m.

It should be noted that the use of radar or LiDAR as one form of detector together with a visual detector having differing wavelength, different focus and differing process time provides a substantial unexpected synergistic effect of the accuracy and therefore effectiveness of the early warning system. This provides a substantial benefit to the industry as prewarnings dramatically increase safety to the people at the monitored zone as well as to the drivers of the vehicles.

The distinctions of the multiple detectors of the invention from the prior art includes the specific fusion of the two for angular resolution/lane ID: which has a specific strategy for fusing radar and camera data. Radar excels at long-range speed/distance detection, and that prior art (often radar-heavy) struggles with angular resolution, leading to false alarms (e.g., identifying a vehicle in the wrong lane). Our visual detector (camera) is key for improving this angular resolution and confirming lane occupancy, especially at short to medium ranges, while mentioning multiple sensors, does not appear to detail this specific complementary fusion logic aimed at solving the angular resolution/false alarm problem in the way we do.

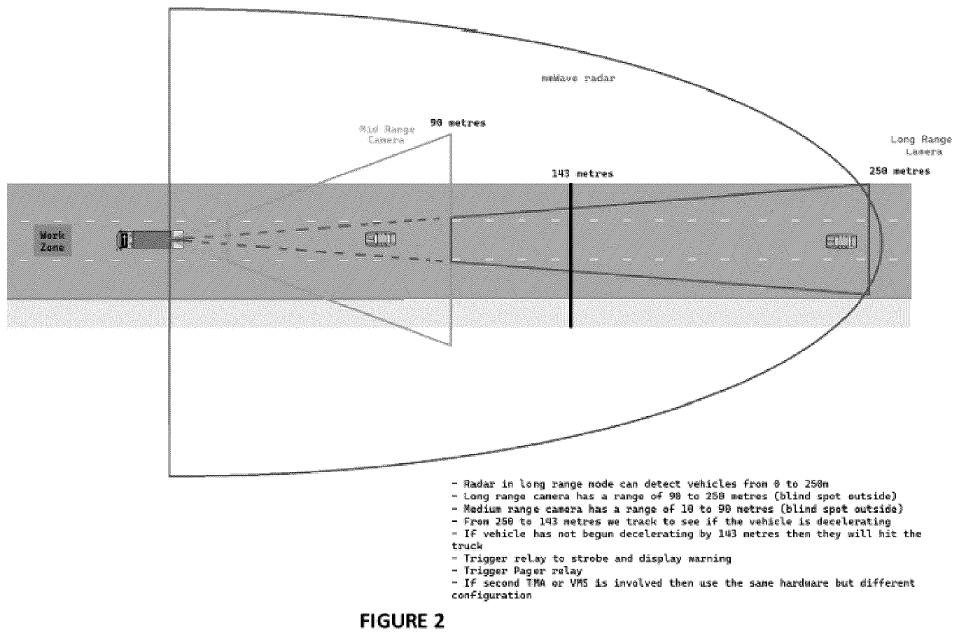

This problem is solved by explicitly targeting the false alarm issue arising from poor lane identification. Our fusion approach described previously and shown in FIG. 2, where a camera confirms radar detection, especially concerning lane position, is a direct technical solution to this problem. Prior art does not use this multisensor approach in solving this precise issue with the same detailed strategy.

Dynamic multiarea assessment is a novel method determining characteristics in “a first distant area and a second distant area” to assess change of expected relative impact.

This comprises a method including determining the characteristics of the tracked vehicle relative to the monitored zone in each of a first distant area and a second distant area of the at least one area forming the watch area to determine an assessed change of expected relative impact of the vehicle on the monitored zone so as to maintain variable assessment and required variable warning in real time.

This results in a more sophisticated tracking and risk update mechanism than what occurs in known risk assessment.

### Multiple Warnings

An important element of the warning system is to include a plurality of alarms with a first alarm for warning the person approaching the monitoring zone, the second alarm to alert the people at the monitoring zone, and the third alarm to alert the people at or near the monitoring zone.

The alarm system can include one or more of: (a) relaying to a first alarm at the monitoring zone to alert the vehicle approaching the monitoring zone of the danger; (b) relaying to a second alarm to alert the people monitoring at the monitoring zone; and/or (c) relaying to a third alarm to alert the people undertaking other actions at or near the monitoring zone such as vehicle service people or first responders.

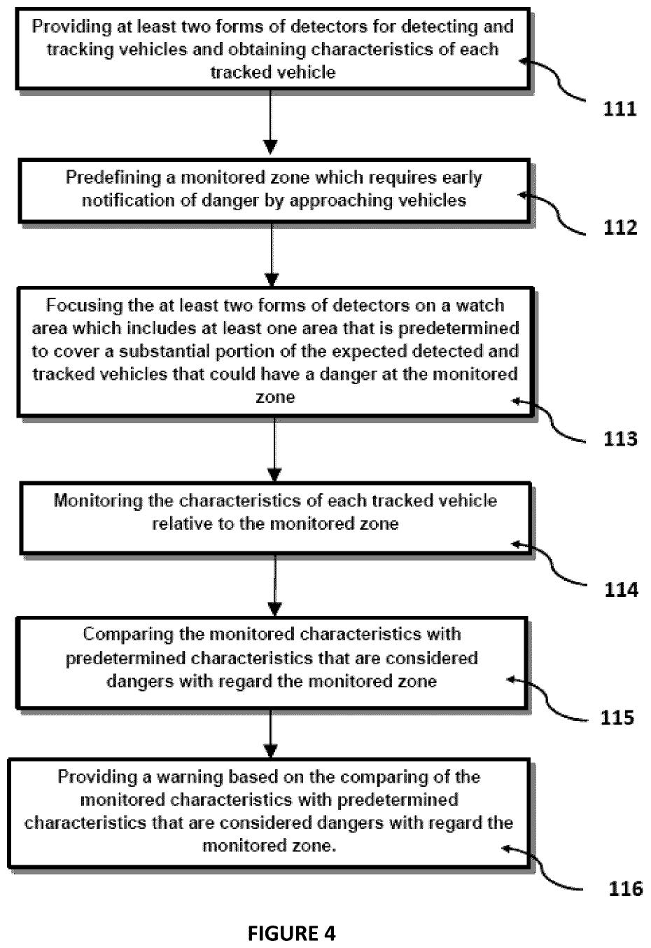

As shown in FIG. 4 this can include a relay to an air horn on the back of the van to alert the public vehicle, beeping sound in the cabin to alert the van or driver and buzzing pagers for responders that might be changing a tyre of a public vehicle in front of the van or driver.

### Predictive Alarm Timing for Latency Compensation

The multidetector warning system of the invention can operate as is but is synergistically improved when combined with a predictive alarm timing. In the real world the connecting alarm system or intervening communication system has real world latency. For an alarm to be accurate about an oncoming vehicle 100 meters away there needs to be no lag time to the alarm system for the vehicle driver being warned to take braking action. If there are seconds delay in triggering the alarm, then the vehicle being warned could be 40 meters closer and only 60 meters away from danger. This does not give sufficient time for the driver to react and brake in time.

The approach to resolve this problem is to modify the cameras and 3D detectors and their synergistic fusion to operate from further distance. However, distance is primed near the 100-meter distance. Therefore, the better solution is the combination to include a predictive alarm timing for latency compensation.

The invention provides this through a method and system enhancement to account for and mitigate delays inherent in triggering external or third-party owned alarm systems.

A new processing module (or enhancement to the “determinator”) is provided within the warning system and incorporates a “future prediction parameter.” This parameter is calculated based on:
the assessed risk and trajectory of an approaching vehicle (as per the current system);
a configurable or learned latency value associated with the specific alarm system(s) to be triggered; and/or
The required time for the alarm to be effective at the target location (e.g., time for personnel to react or a physical barrier to deploy).

The system logic is modified to trigger the alarm earlier than the immediate assessed impact time, by an amount offset by this future prediction parameter, ensuring the alarm's effect (e.g., warning sound, visual alert) arrives at the monitored zone before or at the point of potential impact, not after.

The base application assesses impact, while this synergistic combination specifically addresses and quantifies external alarm system latency.

The introduction of a configurable/learnable latency parameter within the prediction model to ensure “just-in-time” alarm arrival, compensating for known system delays.

Standard early warning systems might trigger based on imminent threat but the improved combination of the invention triggers based on imminent threat+known alarm system response time. It can be seen that the system is not merely predicting a vehicle's future position but predicting it in the context of a known or estimated downstream system delay. This solves a practical problem for system integrators who don't control the final alarm hardware, providing a more reliable “true early warning” despite external system limitations. This is a specific technical solution to the technical problem and particularly when third-party alarm mechanisms are attached that have latency. The algorithm to calculate when to send the trigger signal to achieve an effective alarm at the actual time of need is a critical refinement.

The system provides:
(a) a significantly more effective “true early warning” by ensuring the warning effect (e.g., sound, light) reaches the target location at the optimal time to prevent the risk, rather than arriving too late due to uncompensated system delays; and
(b) increase in overall system reliability and safety, especially when integrated with diverse, third-party alarm infrastructures.

### Enhanced Long-Distance Object Detection Via Radar-Anchored Computer Vision

Another important development is the ability of the system to improve the classification of an object at long distances. This cannot be obtained by the camera alone that might only have 10 pixels on the object. It cannot be obtained by the radar alone which might only have 1 or 2 points. The invention provides a method to improve the accuracy and confidence of computer vision (CV) based object detection and classification at long distances (e.g., 100-300 m) where visual targets are very small (e.g., 10-20 pixels wide).

As discussed, and shown in FIG. 8, the invention provides a tangible creation & process with a specific sensor fusion method and data processing pipeline of the combination of camera of CV and radar.

### Step 1: Radar Data Processing

In this step, radar (a 3D sensor) is used to detect potential objects/targets at long range and applying a clustering algorithm (e.g., DBSCAN, k-means, or custom) to the 3D radar point cloud data to identify distinct groups of radar returns likely corresponding to individual objects.

### Step 2: Projection and CV Anchoring

This step comprises projecting the centroids or bounding boxes of these 3D radar clusters onto the 2D image plane of the CV camera and using these 2D projected locations as “regions of interest” or “anchors” for the CV algorithm.

### Step 3: CV Processing Refinement

The CV algorithm then focuses its detection efforts within or around these radar-suggested 2D locations. The presence of a radar-derived anchor at a location where the CV algorithm detects a low-confidence object which can be used to significantly boost the confidence score of that CV detection, or to initiate a more computationally intensive CV analysis in that specific region. Novelty includes the specific two-stage process of 3D radar clustering, then 2D projection specifically to guide or anchor CV for very small (low-pixel) long-range targets. Using radar-derived regions not just to confirm CV, but to initiate or improve the primary detection capability of CV in challenging long-range scenarios.

Standard CV struggles with very small, distant objects due to limited pixel information. Radar is less affected by object size at range for initial detection.

The invention provides an unexpected intelligent combination: radar which provides robust “there is something there” cues at long range, and these cues are then used to overcome the inherent limitations of CV algorithms when dealing with few pixels. This is not just simple “late fusion” confirmation, but an “early fusion” or “guided detection” approach.

The projection of 3D clusters to 2D anchors for specific use by a CV algorithm to improve its core detection of low-pixel objects is a nonobvious data processing technique.

The system significantly improves detection and classification accuracy of objects (e.g., vehicles) at extended ranges (100-300 m or more) where traditional CV alone would fail or have very low confidence. This leads to earlier warnings and increased safety margins in applications requiring long-distance threat assessment.

HYBRID EDGE-CLOUD PROCESSING ARCHITECTURE WITH INTELLIGENT DATA STREAMING

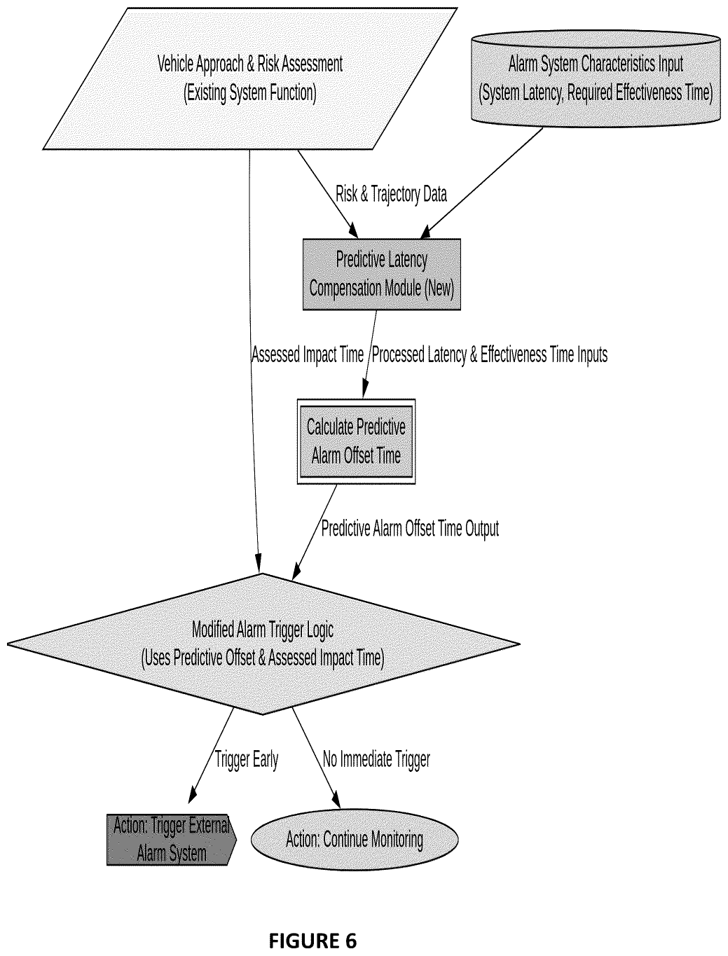

With reference to FIGS. 5, 6, and 7 the invention provides a system architecture that balances on-device (edge) processing for real-time critical events with cloud-based processing for longer term analysis, while optimizing data transmission costs and load. A distributed processing system is provided for a sensor-fusion based warning system.

On-device (edge) processing includes the local compute unit (e.g., on the TMA or sensor unit) which handles all sensor data acquisition (camera, radar). It directly processes data to detect and trigger alarms for immediate, real-time preventative safety events (e.g., imminent collision based on predefined critical rules).

Cloud Processing has the cloud platform being used for tasks not requiring sub-second latency, such as:
Long-term data analytics (e.g., traffic patterns, near-miss trends);
more computationally intensive model training or refinement; and/or archival storage.

Intelligent Data Streaming includes a mechanism where the edge device selectively streams data to the cloud. Instead of continuous full data streams (e.g., all video and radar data), the edge device uses its real-time event detection logic to identify “meaningful events” (e.g., a confirmed dangerous approach, a near-miss, a system trigger). Only data segments (e.g., video clips, radar plots) associated with these meaningful events, potentially with a pre- and post-event buffer, are uploaded to the cloud.

It can be seen that a particular novelty is the specific application of a hybrid edge-cloud architecture to this type of mobile, real-time safety warning system. The intelligent, event-driven data streaming strategy: the edge device itself decides what data is “meaningful” enough to send to the cloud, based on its own real-time processing.

While edge and cloud computing are known, the division of labor (critical real-time safety on edge, noncritical/analytical on cloud) combined with an edge-intelligence-driven data filtering mechanism for cloud uploads is an improved design. This architecture addresses the specific constraints of mobile safety systems needed for immediate response (edge) while also needing data for improvement and analysis (cloud), but with limitations on bandwidth and compute cost. The “intelligent streaming” directly solves the data deluge problem. It can be seen that the system reduces data transmission costs and cloud storage requirements significantly. It ensures real-time critical functions are handled locally for low latency and allows deeper, more complex analysis on the cloud without overwhelming the edge device or communication links. It also improves scalability and operational efficiency.

Privacy-Enhanced Warning System Using Radar with Camera for Setup and Dynamic Zoning

The invention also provides a method and system configuration that prioritizes privacy in industrial or sensitive environments by primarily relying on radar for event detection and not storing video data, while still leveraging camera capabilities for setup and potentially real-time fusion.

There is provided a sensor fusion warning system with a distinct operational workflow for privacy.

### Phase 1: Setup and Zone Definition (Camera-Assisted)

In this phase, the camera system is actively used during initial system setup or when zones need to be reconfigured. A user interface (e.g., touchscreen) displays the camera's live video feed.

Operators can:
(a) manually draw and define monitored zones, danger zones, or exclusion zones directly on the video feed; or
(b) the system can use automated CV techniques (e.g., lane segmentation, object detection) on a temporary basis to suggest or automatically define these zones.

Once defined, these zone boundaries are translated from image coordinates to real-world coordinates or radar sensor coordinates.

### Phase 2: Operational Monitoring (Primarily Radar, Video Not Stored)

In this phase and during normal operation, the radar system is the primary sensor for detecting and tracking objects/vehicles. The camera may still be active and its data may be used in real-time fusion with radar data (e.g., for object classification or improved tracking within the defined zones as per the base patent). Crucially, raw video data from events (e.g., warnings, incidents) is NOT stored or recorded. Only event metadata (e.g., time, location, radar track, type of warning triggered) is logged.

Dynamic zone adjustment is provided by the system which allows for zones to be dynamically reset or adjusted via the touchscreen interface based on changing operational requirements, repeating phase 1 for the adjustment.

The system provides the benefit of the “union-friendly” operational mode where camera is essential for flexible (manual or semiautomated) zone setup, but video is deliberately not stored during event logging to address privacy. The combination of camera-based interactive/automated zone definition with a subsequent privacy-preserving (no video storage) radar-centric monitoring and event logging.

This is an inventive improvement over the prior art where most safety systems aim to capture as much data as possible, including video for incident review. The improvement here is a novel design choice and technical implementation to forgo video storage for privacy reasons, while still using the camera effectively for setup and potentially real-time fusion. This specific workflow (camera for setup/zoning GUI, then radar-primary detection with no video event recording) offers a unique solution to a practical problem in many industrial settings.

As a result, the system significantly enhances user/worker acceptance in privacy-sensitive environments (e.g., industrial sites with union presence) and Allows flexible and accurate zone definition using intuitive visual tools (camera feed) while maintaining a high level of safety through sensor fusion while respecting privacy mandates or concerns.

ADAPTATION FOR VERTICAL RISK DETECTION AND MONITORING

Although primarily shown as a system for use in horizontal traffic use, the system is able to be setup for use at any angle and even at 90° (vertical). Extending the sensor fusion system's capabilities from primarily horizontal risk detection (e.g., approaching vehicles) to include vertical risk detection (e.g., falling materials, objects under crane loads).

The invention provides a method for reconfiguring and adapting the existing sensor suite and processing algorithms for vertical threat assessment.
(a) SENSOR REORIENTATION: Physically rotating or reangling the radar sensor(s) (and potentially cameras) to monitor vertical or near-vertical zones of interest (e.g., area beneath a crane, trajectory of potential falling debris from height).
(b) ALGORITHMIC ADAPTATION (“FLIPPING TRACKING MATH”): Modifying the existing object tracking algorithms (e.g., Kalman filters, particle filters) that were designed for predominantly 2D/horizontal movement. This involves:
   (i) changing the state vector to prioritize vertical position, vertical velocity, and vertical acceleration;
   (ii) adjusting the motion models to better represent falling object trajectories (e.g., incorporating gravity, potential wind effects) rather than vehicle dynamics; and/or
   (iii) redefining collision prediction logic based on vertical intersection with protected zones (e.g., a “worker under load” zone).
(c) Adapting the “determinator” to assess characteristics relevant to vertical risks, such as:
   (i) size and estimated mass (if derivable from radar cross section or fused data) of falling objects; and/or
   (ii) speed and acceleration profile to distinguish controlled lifting from accidental drops.
(d) System Application:
   (i) detecting, tracking, and tracing the path, speed, and size of falling materials; and/or
   (ii) detecting and warning workers positioned unsafely under suspended crane loads.

The application of this specific type of camera-radar fusion early warning system (originally designed for roadway traffic) therefore provides the novel application to the domain of vertical industrial safety and the specific algorithmic modifications described as “flipping the tracking math” to handle predominantly vertical trajectories and risk assessments.

While radar can detect objects in 3D, simply pointing a radar upwards is not sufficient. The invention lies in the adaptation of the entire system's logic, specifically the tracking algorithms and risk assessment (“determinator”), from horizontal vehicle tracking to vertical object tracking (falling items, crane loads).

The “flipping of tracking math” implies a significant reworking of the underlying predictive models and state estimations to be effective and reliable for uniquely vertical hazards, which have different physical characteristics (e.g., gravitational acceleration as a primary force) than roadway vehicles.

This expands the system's utility to a new and critical class of safety applications in industrial environments (e.g., construction, warehousing, manufacturing) where overhead hazards are prevalent and provides early warning for falling objects or unsafe worker positioning relative to overhead loads, significantly improving worker safety.

### Overview

It can be seen that the invention provides an early warning system for providing notification of danger posed by objects relative to a monitored zone, the system comprising: a sensor suite including at least a first sensor of a first modality and a second sensor of a second, distinct modality, the first and second modalities possessing complementary operational characteristics related to object detection and tracking; a data processing unit communicatively coupled to the sensor suite, the data processing unit configured by executable instructions to:
(i) perform a sensor calibration routine to establish a calibrated spatial relationship between data acquired by the first sensor and data acquired by the second sensor;
(ii) implement a multistrategy sensor fusion engine to combine calibrated data from the first sensor and the second sensor to generate fused object data, wherein said sensor fusion engine is configurable to selectively operate using at least one fusion strategy chosen from a group consisting of: a low-level data fusion strategy, a midlevel object feature fusion strategy, and a high-level track fusion strategy;
(iii) receive, via a user interface, a definition for at least one monitored zone, wherein said definition is selectable from a group of zone definition methods consisting of: a 3D world coordinate parametric zone definition, a 2D image-plane interactive zone definition translated to 3D world coordinates or used for 2D projection-based intersection, and a dynamic object-centric zone definition maintained relative to a specific object tracked using the fused object data;
(iv) detect, classify, and track one or more objects within a watch area using the fused object data, thereby generating object tracks with associated state vectors including position, velocity, and classification; and
(v) execute a predictive risk assessment module to determine a risk level for each tracked object relative to the at least one monitored zone by predicting a future trajectory of the tracked object based on its state vector and analyzing potential intersection of said future trajectory with boundaries of the at least one monitored zone; and an alert generation module communicatively coupled to the data processing unit, configured to issue a warning when the determined risk level for a tracked object exceeds a predetermined threshold.

The first sensor modality is radar and the second sensor modality is a vision-based camera, and wherein the complementary operational characteristics include radar's proficiency in range and velocity measurement and its robustness to adverse weather, and the camera's proficiency in angular resolution and object classification.

The sensor calibration routine is selectable from a marker-based calibration method utilizing physical calibration targets and a markerless calibration method utilizing naturally occurring environmental features or object motions observed by both the first and second sensors.

The low-level data fusion strategy implemented by the sensor fusion engine comprises a radar-anchored computer vision process, wherein the first sensor is a radar sensor providing 3D radar point cloud data and the second sensor is a vision-based camera providing 2D image data, The data processing unit is further configured to cluster the 3D radar point cloud data to identify 3D radar cluster, project said 3D radar clusters onto a 2D image plane of the vision-based camera using the calibrated spatial relationship to define 2D anchor regions, and direct a computer vision algorithm operating on the 2D image data to focus analysis within or around said 2D anchor regions to enhance detection or classification confidence for objects, particularly at extended ranges or for low-pixel targets.

The midlevel object feature fusion strategy implemented by the sensor fusion engine comprises independently detecting object features or hypotheses from the first sensor and the second sensor, performing data association to match features or hypotheses corresponding to a same physical object; and employing a state estimation filter to fuse associated features or hypotheses to generate a refined state estimate for the object.

The dynamic object-centric zone definition comprises allowing a user to select a specific reference object being tracked by the system; allowing the user to define a zone geometry relative to said specific reference object's local coordinate frame; and the data processing unit continuously transforming said relative zone geometry into world coordinates based on a current position and orientation of the tracked specific reference object, such that the zone dynamically moves and orients with the reference object.

The predictive risk assessment module is further configured to calculate a time-to-intersection (TTI) or time-to-collision (TTC) for a tracked object relative to a monitored zone, and to elevate the risk level if the tracked object is an approaching vehicle that fails to exhibit a predetermined deceleration characteristic by a critical distance from the monitored zone.

The system can further comprise an intelligent alert timing module configured to determine an alarm system latency associated with the alert generation module or an external warning mechanism, and a required alarm effectiveness time; calculate a predictive alarm offset time based on said alarm system latency, said required alarm effectiveness time, and optionally, the determined risk level; and trigger the alert generation module at a time advanced by said predictive alarm offset time relative to a predicted impact or zone entry time, to compensate for said latencies.

The data processing unit is an on-device edge computing module, and the system further comprises: a communication interface for selectively transmitting data to a remote cloud platform; and an intelligent data streaming logic within the data processing unit, configured to: identify meaningful events based on predefined rules including at least one of: a triggered critical alarm, a detected near-miss incident, a sensor anomaly, an object behavior pattern flagged as noteworthy, or an event matching a cloud-requested pattern for retraining; and package and transmit data segments associated with said meaningful events to the remote cloud platform for at least one of: long-term analytics, machine learning model training or refinement, or archival storage; wherein results from the remote cloud platform, including updated models or refined rules, are transmittable back to the on-device edge computing module.

The system is configurable to operate in a privacy-enhanced mode, wherein during operational monitoring: the vision-based camera data is used in real-time for sensor fusion to aid object detection and classification; and raw video data from the vision-based camera pertaining to detected events or triggered warnings is not stored, while event metadata excluding raw video is logged.

The sensor suite is orientable, and the data processing unit is configurable with adapted object tracking algorithms and motion models, to perform vertical risk detection and monitoring for hazards such as falling objects or objects suspended at height, wherein said adapted algorithms prioritize vertical components of motion and incorporate gravitational effects.

The invention also provides a method for providing an early warning of danger posed by objects relative to a monitored zone, the method comprising: acquiring first sensor data from a first sensor of a first modality and second sensor data from a second sensor of a second, distinct modality, said first and second modalities possessing complementary operational characteristics; performing, using a data processing unit, a sensor calibration routine to establish a calibrated spatial relationship between the first sensor data and the second sensor data; combining, using a multistrategy sensor fusion engine within the data processing unit, the calibrated first sensor data and second sensor data to generate fused object data, wherein said combining selectively employs at least one fusion strategy chosen from a group consisting of: a low-level data fusion strategy, a midlevel object feature fusion strategy, and a high-level track fusion strategy; receiving, via a user interface, a definition for at least one monitored zone, wherein said definition is selectable from a group of zone definition methods consisting of: a 3D world coordinate parametric zone definition, a 2D image-plane interactive zone definition, and a dynamic object-centric zone definition maintained relative to a specific object tracked using the fused object data; detecting, classifying, and tracking, using the data processing unit, one or more objects within a watch area based on the fused object data, thereby generating object tracks with associated state vectors; predicting, using the data processing unit, a future trajectory for each tracked object based on its state vector; determining, using the data processing unit, a risk level for each tracked object by analyzing potential intersection of said future trajectory with boundaries of the at least one monitored zone; and issuing, via an alert generation module, a warning when the determined risk level exceeds a predetermined threshold.

The low-level data fusion strategy comprises radar-anchored computer vision, includes identifying 3D radar clusters from radar data provided by the first sensor; projecting said 3D radar clusters onto a 2D image plane of a vision-based camera providing the second sensor data, to define 2D anchor regions; and focusing a computer vision analysis on 2D image data from the vision-based camera within or around said 2D anchor regions to enhance object detection or classification.

Defining the dynamic object-centric zone comprises: selecting a specific reference object being tracked; defining a zone geometry relative to said specific reference object's local coordinate frame; and continuously transforming said relative zone geometry into world coordinates based on a current position and orientation of the tracked specific reference object.

Determining an alarm system latency and a required alarm effectiveness time; calculating a predictive alarm offset time based on said alarm system latency, said required alarm effectiveness time, and the determined risk level; and advancing a trigger time for issuing the warning by said predictive alarm offset time relative to a predicted impact or zone entry time.

Identifying meaningful events can be based on at least one of: a triggered critical alarm by the data processing unit, a detected near-miss incident, a sensor anomaly detected by the data processing unit, an object behavior pattern flagged by the data processing unit, or an event matching a cloud-platform-requested pattern; selectively transmitting data segments associated with said meaningful events from the data processing unit, operating as an edge device, to a remote cloud platform for at least one of: long-term analytics, machine learning model training or refinement, or archival storage; and receiving, at the data processing unit, updated machine learning models or refined operational rules from the remote cloud platform.

The first sensor is a radar sensor and the second sensor is a vision-based camera, the method further comprising operating in a privacy-enhanced mode by: utilizing vision-based camera data in real-time for said combining step to aid object detection and classification; and refraining from storing raw video data from the vision-based camera pertaining to issued warnings, while logging event metadata excluding said raw video.

The orienting the sensor suite to monitor a vertical or near-vertical zone of interest includes adapting the step of detecting, classifying, and tracking objects, and the step of predicting a future trajectory, to prioritize vertical components of motion and incorporate gravitational effects for vertical risk detection.

INTERPRETATION

### EMBODIMENTS

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward,” “rearward,” “radially,” “peripherally,” “upwardly,” “downwardly,” and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e., to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the for early notification of danger by approaching vehicles to a monitored zone including emergency workers, roadworks and vehicle breakdown industries.

What is claimed is:

1. A warning system for early notification of danger by approaching objects to a monitored zone, the system comprising:
a. at least two distinct types of detectors configured to detect and track vehicles and obtain characteristics of a tracked vehicle relative to the monitored zone;
b. a processor communicatively coupled to the at least two distinct types of detectors, the processor configured to:
i. receive the characteristics of the tracked vehicle relative to the monitored zone; and
ii. assess the expected relative impact of the object on the monitored zone; and
c. an alarm system communicatively coupled to the processor, the alarm system configured to provide an alarm action based on a predetermined danger level associated with the assessed expected relative impact of the object to the monitored zone.

2. The warning system of claim 1 wherein the monitored zone is predefined and wherein a watch area is defined relative to the monitored zone wherein the watch area includes an area that is predetermined to cover trajectories of detected and tracked objects that are expected to provide the predetermined danger level associated with the assessed expected relative impact of the object to the monitored zone.

3. The warning system of claim 2 wherein the watch area includes at least a first distant area and a second distant area, both spatially related to the monitored zone and within the watch area and wherein the at least two distinct types of detectors are configured to monitor the first distant area or the second distant area, said detectors being selected based on possessing at least partially complementary operational characteristics across one or more of a plurality of distinct performance parameters wherein the complementary nature of said characteristics enables the system to:
i. leverage a strength of a first of said detector types to compensate for a corresponding weakness or limitation of a second of said detector types with respect to at least one of said performance parameters; and
ii. perform crosschecking of detections derived from said detector types;
thereby enhancing overall detection reliability and limiting false alarms.

4. The warning system of claim 3 wherein the at least two distinct types of detectors comprise a combination of at least one visual camera and at least one sensor selected from the group consisting of radar and LiDAR, said combination inherently exhibiting said at least partially complementary operational characteristics across performance parameters including one at least of illumination dependency, weather robustness, angular resolution, and target classification capability.

5. The warning system of claim 3 wherein the plurality of distinct performance parameters, which contribute to the complementary operational characteristics, further includes parameters related to sensor configuration or intrinsic capabilities, selected from the group consisting of: detection range, noise immunity, velocity tracking accuracy, height tracking capability, distance tracking accuracy, different focal lengths, different depths of field, and different sensor data processing times, to ensure robust assessment of tracked vehicles.

6. The warning system of claim 3 wherein the plurality of distinct performance parameters comprises at least three parameters selected from the group consisting of: performance under varying illumination conditions, performance in adverse weather conditions, susceptibility to signal noise, maximum and minimum detection range, angular resolution, accuracy of velocity tracking, accuracy of height tracking, accuracy of distance tracking, and capability for target classification.

7. The warning system of claim 3 wherein the at least two forms of detectors are a visual camera and at least one sensor selected from the group consisting of radar and LiDAR are configured to cooperatively detect and track the objects which are vehicles within the watch area at least a first distance of at least 180 meters and obtain said characteristics of the tracked vehicle at each watch area relative to the monitored zone, wherein the at least two distinct types of detectors are configured to detect and track objects approaching the monitored zone from a plurality of different angles of incidence and over a range of relative velocities.

8. The warning system of claim 3 wherein the at least two forms of detectors are a visual camera and at least one sensor selected from the group consisting of radar and LiDAR are configured to cooperatively detect and track the objects which are vehicles within the watch area including for use in horizontal traffic use (e.g., approaching vehicles) or vertical risk detection (e.g., falling materials, objects under crane loads).

9. The warning system of claim 3 wherein the detectors include a least one auxiliary detector locatable at a distance from the monitored zone and wirelessly connected to the warning system so as to provide an extended warning of a distant danger and incorporate into a warning at the monitored zone.

10. The warning system of claim 1 wherein the processor is further configured to:
a. receive monitored input from each of the at least two distinct types of detectors;
b. determine a distance of the tracked vehicle to the monitored zone and an apparent speed of the tracked vehicle; and
c. calculate a predictive alarm timing for latency compensation, wherein the predictive alarm timing is based on:
i. an assessed risk and trajectory of the approaching tracked vehicle;
ii. a configurable or learned latency value associated with the alarm system; and
iii. a required time for the alarm action to be effective at a target location within or near the monitored zone.

11. The warning system of claim 1 wherein the alarm action includes one or more of:
a. an audible warning;
b. a visual warning;
c. an instructional sign warning; and
d. a haptic sensory warning.

12. The warning system of claim 1 wherein the alarm system is configured to perform one or more of:
a. transmitting a first alert signal to an approaching vehicle to warn of danger at the monitored zone;
b. activating a second alert signal, such as an air horn or beeping sound, to alert personnel at the monitored zone; and
c. activating a third alert signal, such as a pager notification, to alert personnel undertaking actions at or near the monitored zone, including vehicle service personnel or first responders.

13. The warning system of claim 1 wherein the alarm system provides a graded warning based on a grade of the predetermined dangers and including an emergency activation.

14. The warning system of claim 1 wherein the alarm system is configured to provide a graded warning based on a severity level of a predetermined danger, and wherein the alarm system is further configured to initiate an emergency activation for highest severity dangers.

15. The warning system of claim 1 wherein the at least two distinct types of detectors are selected from modalities including:
a. a radar detector, optionally a short-range Doppler radar detector;
b. a vision-based detector (camera);
c. a thermal-based detector (camera);
d. a sonar detector; and
e. a LiDAR detector.

16. A method of early notification of danger by approaching objects relative to a monitored zone, the method including the steps of:
a. providing at least two distinct types of detectors to detect and track moving objects and obtain characteristics of each tracked object;
b. predefining a monitored zone which requires early notification of danger by approaching objects;
c. configuring the at least two distinct types of detectors to monitor a watch area, the watch area including at least one area predetermined to cover trajectories of expected detected and tracked objects that pose a potential threat to the monitored zone;
d. monitoring the characteristics of each tracked object relative to the monitored zone;
e. comparing the monitored characteristics with predetermined characteristics that are considered dangers with regard the monitored zone; and
f. providing a warning based on the comparing of the monitored characteristics with predetermined characteristics that are considered dangers with regard the monitored zone and wherein the predetermined characteristics that are considered dangers with regard the monitored zone are related to the people and assets at the monitored zone.

17. The method of claim 16 including further comprising classifying an object at long distances using sensor fusion of data from a camera and a radar detector, including the steps of:
a. processing radar data from the radar detector to detect potential targets at long range and applying a clustering algorithm to identify 3D radar clusters;
b. projecting one or more centroids or bounding boxes of the 3D radar clusters onto a 2D image plane of the camera;
c. using the projected 2D locations as regions of interest or anchors for a computer vision (CV) algorithm operating on image data from the camera; and
d. refining detection by applying the CV algorithm to focus detection efforts within or around the radar-suggested 2D locations, thereby guiding CV detection for small, low-pixel, long-range targets.

18. The method of claim 17 wherein the predetermined characteristics that are considered dangers with regard to the monitored zone are related to:
a. the environmental hazards at the monitored zone; and/or
b. dangers with regard the objects approaching and/or entering the monitored zone.

19. The method of claim 18 including determining the characteristics of the tracked object relative to the monitored zone in each of a first distant area and a second distant area of the at least one area forming the watch area to determine an assessed change of expected relative impact of the object on the monitored zone so as to maintain variable assessment and required variable warning in real time.

20. The method of claim 19 further comprising:
a. processing first criteria relating to imminent collision detection based on predefined critical rules on a local compute unit associated with the detectors, said local compute unit handling sensor data acquisition and directly processing data to trigger alarms for immediate real-time preventative safety events; and
b. performing remote processing of second criteria not requiring sub-second latency, including long-term data analytics such as traffic patterns or near-miss trends, on a cloud platform.
